(19) United States
(12) Patent Application Publication
(10) Pub. No.: US 2025/0069056 A1
(43) Pub. Date: Feb. 27, 2025

(54) IMPAIRED MODE FOR A MOBILE DEVICE

(71) Applicant: Motorola Mobility LLC, Chicago, IL (US)

(72) Inventors: Krishnan Raghavan, Bangalore (IN); Rahul Sahadevan, Bengaluru (IN); Nakul Patel, Bangalore (IN)

(73) Assignee: Motorola Mobility LLC, Chicago, IL (US)

(21) Appl. No.: 18/237,929

(22) Filed: Aug. 25, 2023

(51) Int. Cl. G06Q 20/32; G06Q 20/38; G06Q 20/40

(52) U.S. Cl. CPC G06Q 20/3224; G06Q 20/388; G06Q 20/4016

(57) ABSTRACT

Techniques for impaired mode for a mobile device are described and are implementable to enable data transactions to be controlled based on different state conditions. For instance, different state conditions of a mobile device can indicate that a user of the mobile device may be in an impaired state. In such scenarios the mobile device may be transitioned to an impaired mode where data transactions are subject to transaction constraints.

### BACKGROUND

The use of network-based finance systems has become commonplace across the world. For instance, users can perform a wide variety of different financial transactions using a network-based finance application, such as using a portable device, e.g., a smartphone. While the availability of finance applications can provide a great deal of convenience, it is not without risks. For instance, users may engage in financial transactions that they later regret. A user in a compromised state, for example, may experience impaired judgement and purchase a product or make a financial transaction that the user may not normally do in a normal state.

### BRIEF DESCRIPTION OF THE DRAWINGS

Aspects of impaired mode for a mobile device are described with reference to the following Figures. The same numbers may be used throughout to reference similar features and components that are shown in the Figures. Further, identical numbers followed by different letters reference different instances of features and components described herein.

FIG. 1 illustrates an example environment in which aspects of impaired mode for a mobile device can be implemented.

FIG. 2a depicts an account GUI as part of an example scenario for impaired mode for a mobile device.

FIG. 2b depicts a security GUI as part of an example scenario for impaired mode for a mobile device.

FIG. 2c depicts an impaired mode GUI as part of an example scenario for impaired mode for a mobile device.

FIG. 3 illustrates a flow chart depicting an example method for impaired mode for a mobile device in accordance with one or more implementations.

FIG. 4 illustrates a flow chart depicting an example method for impaired mode for a mobile device in accordance with one or more implementations.

FIG. 5 illustrates a flow chart depicting an example method for impaired mode for a mobile device in accordance with one or more implementations.

FIG. 6 illustrates a flow chart depicting an example method for impaired mode for a mobile device in accordance with one or more implementations.

FIG. 7 illustrates a flow chart depicting an example method for impaired mode for a mobile device in accordance with one or more implementations.

FIG. 8 illustrates a flow chart depicting an example method for impaired mode for a mobile device in accordance with one or more implementations.

FIG. 9 illustrates various components of an example device in which aspects of impaired mode for a mobile device can be implemented.

### DETAILED DESCRIPTION

Techniques for impaired mode for a mobile device are described and are implementable to control processing of data transactions (e.g., the transfer of high priority data, financial transactions, etc.) based on different state conditions. For instance, the described techniques enable a mobile device, based on different device state conditions, to transition to an impaired mode where processing of data transactions may be subject to certain transaction constraints.

For instance, consider a scenario in which a user visits a pub with friends after work to socialize and relax. In such a scenario after a few drinks the user's judgement may become impaired due to intoxication. Further, while at the pub the user may interact with a payment application on their mobile phone and/or other form of user payment account (e.g., a credit card) to purchase a product, e.g., goods and/or services. However, due to their impaired judgement, the user may want to purchase a product that the user would not normally purchase in an unimpaired state. For instance, at some point during the evening the user may wish to use the payment application and/or other user account access to purchase a round of drinks for the entire pub.

Accordingly, in such a scenario, techniques described herein can be employed to detect that the user may be in an impaired state (e.g., intoxicated) and automatically transition their mobile device to an impaired mode where data transactions such as a financial transaction are subject to certain transaction constraints. For instance, certain state conditions associated with the mobile device can indicate that the user is or may at some point be in an impaired state. Examples of such state conditions include location (e.g., at a location that serves alcohol), a time parameter (e.g., at a day and time where the user may frequently consume alcohol), persons in proximity to the mobile device (e.g., identities of persons with which the user frequently consumes alcohol), motion of the mobile device (e.g., motion patterns that may indicate possible intoxication), etc.

Returning to the example scenario above and with the user's mobile device in an impaired mode, the attempt to purchase a round of drinks for the entire pub may be subject to transaction constraints, e.g., restricted. For instance, a maximum spending limit may be enforced on the user's payment account (e.g., the payment application and/or other form of user account) while the mobile device is in the impaired mode. As another example the complexity of an authentication method for a payment transaction can be increased. As yet another example a transaction challenge can be presented to the user, such as a set of questions that the user must answer correctly before the payment application will allow the purchase to proceed. Accordingly, based on one or more of the transaction constraints, the user's purchase request may be reduced in amount or denied altogether. Alternatively, if the user successfully answers the transaction challenge, the purchase request may be allowed.

In addition to protecting a potentially impaired user of the payment application based on the user's own actions, the described techniques can mitigate a security risk that may occur if another person obtains the user's mobile device while the user is in an impaired state. For instance, with the user's mobile device in the impaired mode, when another person attempts to perform a payment transaction using the payment application, the payment transaction may be subject to the transaction constraints such that the transaction is restricted or denied.

While the examples above are discussed in the context of financial transactions, it is to be appreciated that the described techniques are equally applicable to other types of data transactions, such as the transfer of sensitive data. For instance, while a user's mobile device is in an impaired mode the user may attempt to communicate (e.g., transmit) sensitive data to another device. Examples of sensitive data include security-related data (e.g., passwords, personal identification numbers (PIN), security keys, etc.), national identification numbers, proprietary and/or confidential enterprise data, health data, insurance data, etc. Accordingly, the user's attempt to transfer the sensitive data may be restricted and/or denied, such as based on various transaction constraints. For instance, the various implementations detailed herein can be applied to determine whether to allow or deny the request to transfer the sensitive data while the mobile device is in the impaired mode.

Accordingly, techniques described herein enable processing of data transactions to be controlled based on detection of potential user impairment. In implementations, a data transaction represents a payment transaction, an attempt to transfer sensitive data, a login attempt, a password change attempt, etc. For instance, data transactions such as digital payment transactions involve generating, transmitting, and processing various types of data and across a variety of different systems and networks. Thus, digital payment transactions can be characterized as sets of computational operations much like other operations of a computing device and/or set of computing devices. Accordingly, by controlling data transactions based on potential user impairment, the described techniques can increase data security and conserve system resources (e.g., memory, processor bandwidth, network bandwidth, etc.) that may otherwise be used to detect and correct such data transactions, and thus the described techniques can improve the operation of computing devices and data networks.

While features and concepts of impaired mode for a mobile device can be implemented in any number of environments and/or configurations, aspects of the described techniques are described in the context of the following example systems, devices, and methods. Further, the systems, devices, and methods described herein are interchangeable in various ways to provide for a wide variety of implementations and operational scenarios.

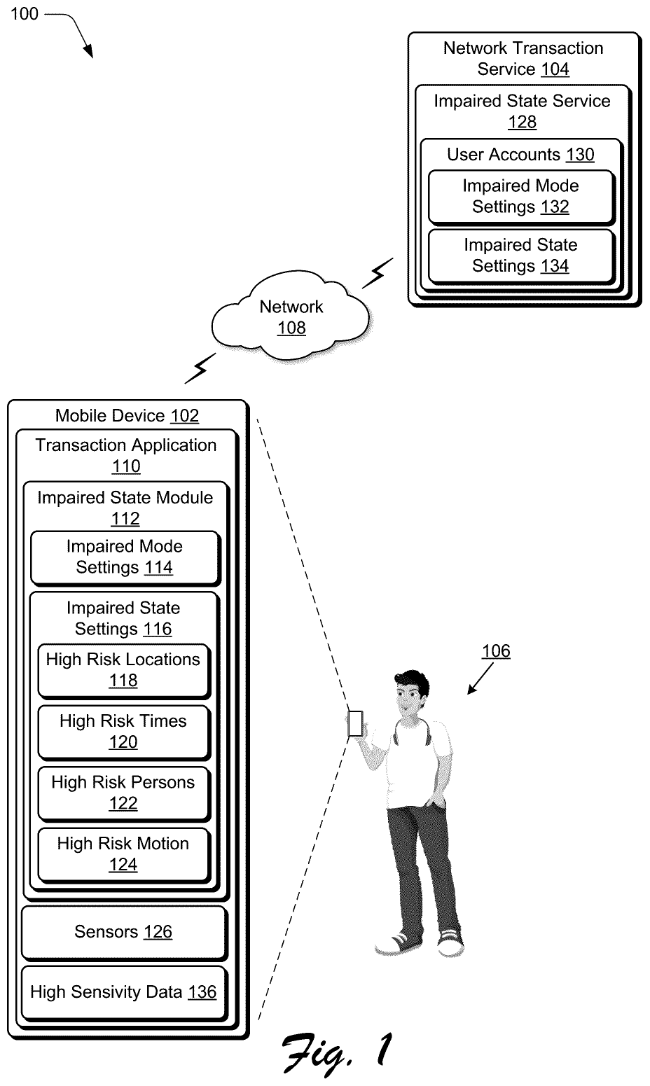

FIG. 1 illustrates an example environment 100 in which aspects of impaired mode for a mobile device can be implemented. The environment 100 includes a mobile device 102 and a network transaction service 104. The mobile device 102 represents a device that can be used by a user 106 to manage different data transactions, e.g., finance transactions, transfer of sensitive data, etc. The mobile device 102, for instance, represents a device that can be carried by the user 106 to enable the user 106 to perform data transactions at different locations.

The network transaction service 104 represents a network-based service that is accessible to the mobile device 102 via a network 108. The network transaction service 104 can be implemented by various entities, such as a banking entity, a payment service, an enterprise entity, a trading entity, and/or combinations thereof. The user 106, for instance, can utilize a transaction application 110 on the mobile device 102 to access the network transaction service 104 to perform different finance transactions, such as to transfer value amounts (e.g., monetary values) for different purposes. For example, the user 106 can interact with the transaction application 110 to purchase products, such as goods and/or services.

Further to the environment 100 the transaction application 110 includes an impaired state module 112 which represents functionality to perform various aspects of impaired mode for a mobile device described herein. For instance, the impaired state module 112 includes impaired mode settings 114 and impaired state settings 116 which specify different parameters for controlling an impaired mode for the mobile device 102. In implementations the impaired mode settings 114 can be configured to control whether an impaired mode is active or inactive on the user device and can specify different parameters for controlling an impaired mode. The impaired mode settings 114, for instance, can specify different data transaction constraints to be applied in an impaired mode, different actions to be taken in an impaired mode, and so forth.

The impaired state settings 116 identify different state conditions for specifying when an impaired mode is to be activated. The impaired state module 112, for instance, can utilize the impaired mode settings 114 and the impaired state settings 116 to activate, control, and deactivate impaired modes.

The impaired state settings 116 include different state conditions including high risk locations 118, high risk times 120, high risk persons 122, and high risk motion 124. The high risk locations 118 represent data that describes different locations that may be considered as high risk for user impairment and may represent various types of locations, such as geographical locations (e.g., geographical coordinates), place names (e.g., businesses, residences, etc.), physical addresses, location types (e.g., pubs, restaurants, nightclubs, etc.), and so forth. The high risk times 120 represent data that describes different times (e.g., days and/or times of day, etc.) that may be considered as high risk for user impairment. The high risk persons 122 represent data that describes persons (other than the user 106) whose presence with the user 106 may be considered as high risk for user impairment. The high risk persons 122 can be specified in different ways, such as identities and/or physical attributes for persons known to be of high risk.

The high risk motion 124 represents data that describes different types of motion (e.g., of the mobile device 102 and/or the user 106) that may be considered as high risk for user impairment. For instance, the high risk motion 124 can describe different types and combinations of user motion that may indicate likely impairment, such as stumbling, weaving, erratic gait (e.g., as compared with a user's normal gait), and so forth.

These different examples of impaired state settings 116 can be combined in a variety of different ways to determine a likelihood that the user 106 may be in an impaired state. For instance, the high risk locations 118, the high risk times 120, the high risk persons 122, and/or the high risk motion 124 can be combined to generate instances of user state that may correlate to likely impairment.

The mobile device 102 also includes sensors 126 are representative of functionality to detect various physical and/or logical phenomena in relation to the mobile device 102, such as motion, light, image detection and recognition, time and date, position, location, touch detection, sound, temperature, and so forth. Examples of the sensors 126 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth. The sensors 126, however, can include a variety of other sensor types in accordance with the implementations discussed herein.

According to implementations, the sensors 126 can generate sensor data that can be utilized by the impaired state module 112 to determine a likelihood that the user 106 is in an impaired state, such as to determine occurrence of the high risk locations 118, the high risk times 120, the high risk persons 122, the high risk motion 124, and/or combinations thereof. For instance, in the context of high risk persons 122, sensor data can be used to recognize identities of persons in proximity to the mobile device 102, such as using various types of biometric identification.

The network transaction service 104 includes various data and functionality for aspects of impaired mode for a mobile device, including an impaired state service 128 and user accounts 130. In implementations the impaired state service 128 can interface with the impaired state module 112 on the mobile device 102 to enable aspects described herein. The user accounts 130 represent information defining different user-specific settings for different users of the network transaction service 104. The user accounts 130, for instance, include a user account 130 for the user 106 of the mobile device 102. The user accounts 130 include impaired mode settings 132 and impaired state settings 134 that represent settings that can be configured and customized for each user account 130. In implementations the impaired mode settings 132 and the impaired state settings 134 include at least some of the impaired mode settings 114 and the impaired state settings 116, respectively, of the impaired state module 112.

Further to the environment 100 the mobile device 102 includes high sensitivity data 136 which represents sensitive (e.g., protected) data associated with the user 106 and/or the mobile device 102. According to implementations a data transaction can include the transfer (e.g., transmission) of the high sensitivity data 136 from the mobile device 102 to an external location, such as another device and/or a network location.

The mobile device 102 and the network transaction service 104 can be implemented in various ways and include various functionality, examples of which are discussed below with reference to the example device 900 of FIG. 9. Further, the network 108 can represent a combination of wired and wireless networks via which the mobile device 102 and the network transaction service 104 can participate in various types of communication, such as wired and/or wireless data communication.

Having discussed an example environment in which the disclosed techniques can be performed, consider now some example scenarios and implementation details for implementing the disclosed techniques.

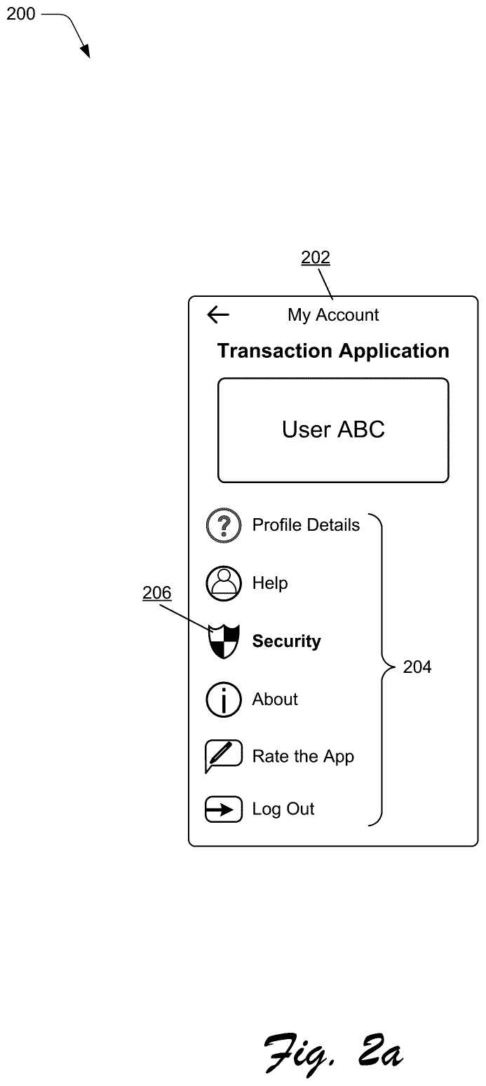

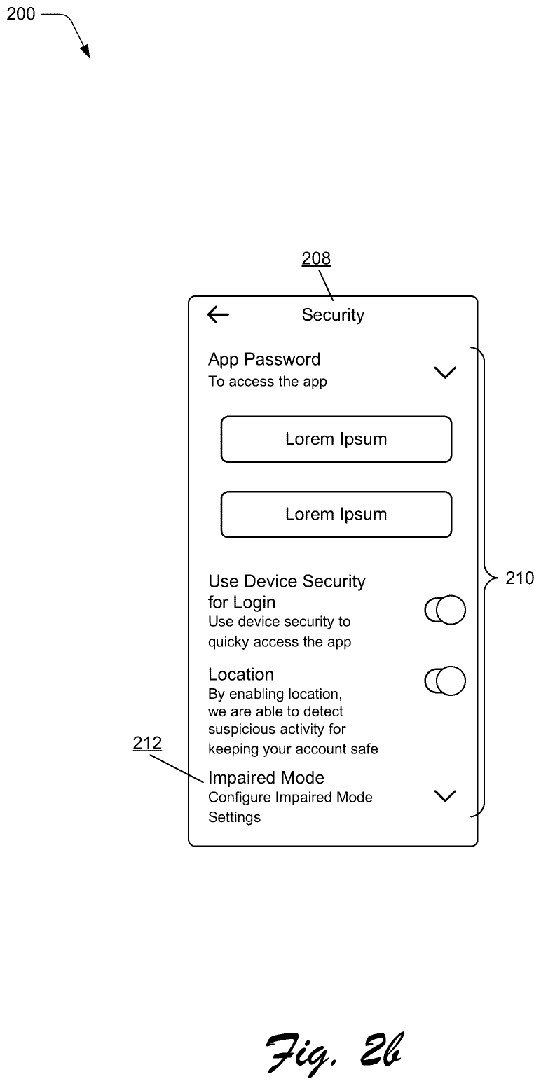

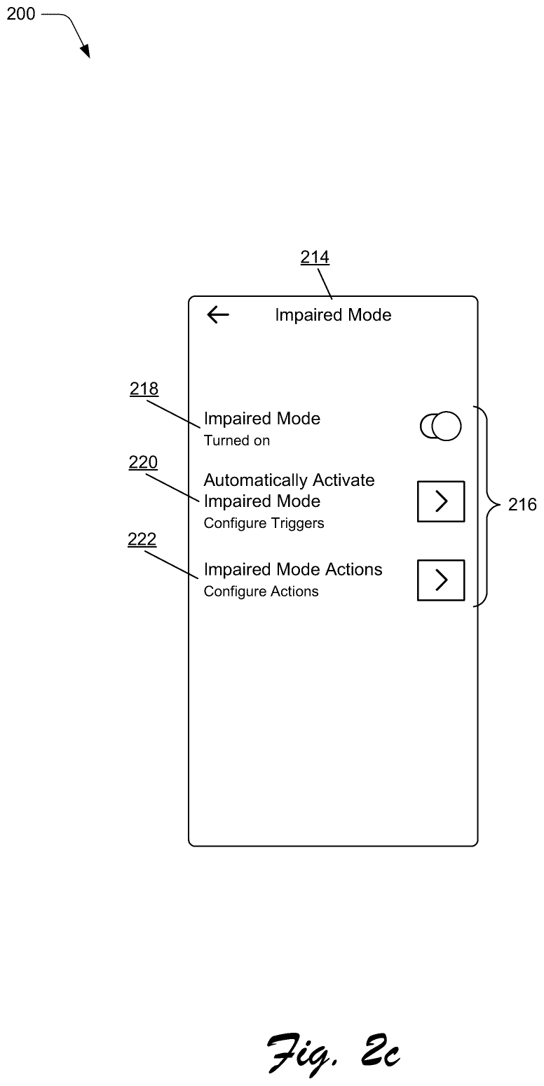

FIGS. 2a-2c depict aspects of an example scenario 200 for configuring an impaired mode in accordance with one or more implementations. The scenario 200 can be implemented in environment 100 and incorporates attributes of the environment 100 introduced above.

FIG. 2a depicts an account GUI 202 as part of the example scenario 200. The account GUI 202, for instance, enables different settings and information for the transaction application 110 to be accessed and configured. Further, the account GUI 202 can be associated with a particular user account 130. The account GUI 202 includes an information and settings region 204 that includes different selectable indicators (e.g., selectable icons) that are each selectable to access information about the transaction application 110 and/or to configure settings of the transaction application 110. The information and settings region 204 includes a security indicator 206 that is selectable to access, view, and configure security settings of the transaction application 110. Further to the scenario 200 a user selects the security indicator 206 to access security settings of the transaction application 110.

FIG. 2b depicts a security GUI 208 as part of the example scenario 200. According to implementations the security GUI 208 enables different security settings of the transaction application 110 to be viewed and configured. The security GUI 208, for example, is presented in response to selection of the security indicator 206 from the account GUI 202. The security GUI 208 includes a settings region 210 that identifies different security settings and provides configurability of at least some of the security settings. The settings region 210 includes an impaired mode indicator 212 that is selectable to view and configure different settings of an impaired mode. Accordingly, as part of the scenario 200 a user selects the impaired mode indicator 212 to access different impaired mode settings of the transaction application 110.

FIG. 2c depicts an impaired mode GUI 214 as part of the example scenario 200. According to implementations the impaired mode GUI 214 enables different impaired mode settings of the transaction application 110 to be viewed and configured. For instance, selection of the impaired mode indicator 212 from the security GUI 208 causes the impaired mode GUI 214 to be presented. The impaired mode GUI 214 includes a settings region 216 that identifies different impaired mode settings and enables at least some of the settings to be configured.

In this example the settings region 216 includes a manual activation control 218, an automatic activation control 220, and a mode actions control 222. The manual activation control 218 is configured to receive user input to expressly activate and deactivate an impaired mode. For instance, user selection of the manual activation control 218 can activate and deactivate an impaired mode. The automatic activation control 220 is selectable to enable various automatic impaired mode trigger events to be configured and/or defined. For instance, selection of the automatic activation control 220 enables the impaired state settings 116 to be configured. The mode actions control 222 is selectable to enable different impaired mode actions to be configured and/or defined. Selection of the mode actions control 222, for instance, enables the impaired mode settings 114 to be configured, such as to configure different transaction constraints that can be applied to data transactions when an impaired mode is active. According to implementations, the various GUIs described herein are displayable via the transaction application 110 on the mobile device 102.

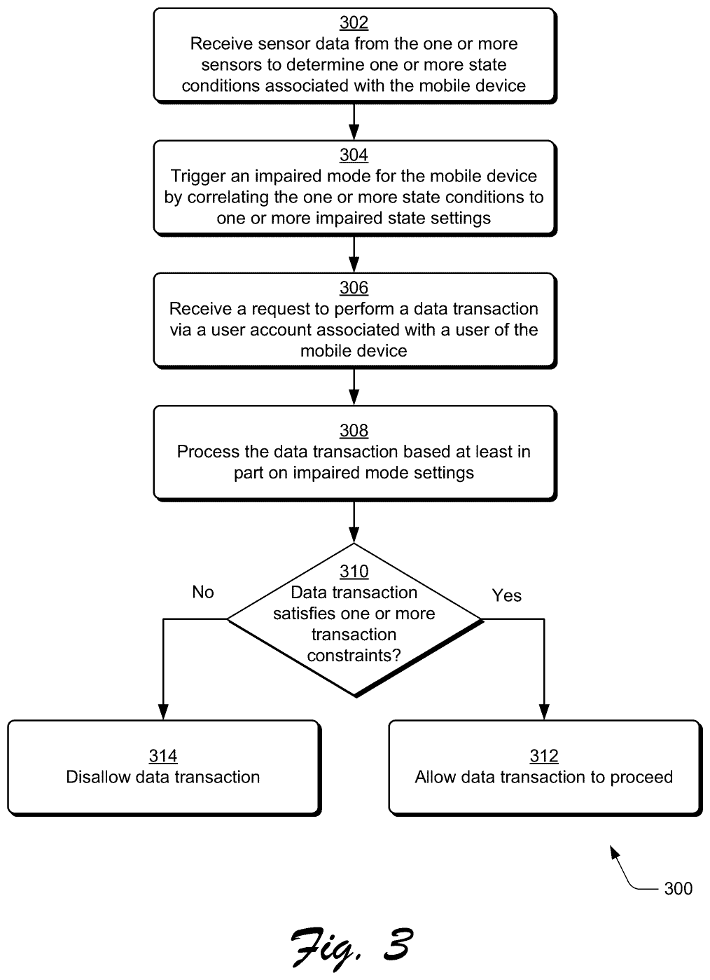

FIG. 3 illustrates a flow chart depicting an example method 300 for impaired mode for a mobile device in accordance with one or more implementations. Operations of the method 300, for instance, may be performed in the context of the environment 100, such as by the transaction application 110 on the mobile device 102.

At 302 sensor data is received from the one or more sensors to determine one or more state conditions associated with the mobile device. The impaired state module 112, for instance, receives various types of sensor data from the sensors 126. At 304 an impaired mode for the mobile device is triggered by correlating the one or more state conditions to one or more impaired state settings. The impaired state module 112, for example, determines that the one or more state conditions correspond to one or more impaired states identified in the impaired state settings 116. The one or more state conditions, for example, can correspond to a high risk location 118, a high risk time 120, a high risk person 122, a high risk motion 124, and/or combinations thereof.

In at least one implementation, and in response to the impaired mode being triggered, an option to perform a proactive data transaction can be presented. For instance, upon detecting the transition to the impaired mode and prior to a request to perform a data transaction being received, the transaction application 110 can prompt the user 106 to perform a proactive payment transaction such as at a current location of the mobile device 102. In at least one implementation the proactive payment transaction may be subject to different transaction constraints described herein.

At 306 a request is received to perform a data transaction via a user account associated with a user of the mobile device. The user 106, for instance, interacts with the transaction application 110 to request a data transaction, and/or initiates a data transaction outside the transaction application such as using a card (e.g., credit card, debit card, etc.) and/or other form of user account access. The data transaction, for example, represents a payment transaction (e.g., a transfer of value) from the user's account to a different party. At 308 the data transaction is processed based at least in part on impaired mode settings. The transaction application 110, for example, utilizes the impaired mode settings 114 to apply one or more transaction constraints to processing of the data transaction.

At 310 it is determined if the data transaction satisfies one or more transaction constraints of the impaired mode settings. If the data transaction satisfies the one or more transaction constraints (“Yes”), at 312 the data transaction is allowed to proceed. The transaction application 110, for example, determines that the data transaction meets one or more applied transaction constraints and thus the data transaction is allowed to proceed. Alternatively or additionally where the data transaction involves user account access separately from the transaction application 110, the access to the user account can be permitted to proceed. For example, if the transaction constraint represents a maximum spend threshold and the data transaction is below the maximum spend threshold, the data transaction may be allowed to proceed. Further, if the mobile device is not present at a high risk location 118 the data transaction may be allowed to proceed.

As another example consider that the transaction constraint represents a change in authentication mode with the transaction application 110, such as a change from fingerprint authentication and/or facial recognition to a more complex authentication mode such as PIN authentication and/or other 2-factor authentication. If the user is able to successfully perform the more complex authentication mode the data transaction may be permitted to proceed.

As another example the transaction constraint can represent specific transaction types that are disallowed while an impaired mode is active, such as a transactions that involve reoccurring payments, transactions with unverified vendors (e.g., vendors that may be unsafe), transactions with entities specifically identified as disallowed, etc. In another example the transaction constraint can indicate that changes to authentication-related information are disallowed while an impaired mode is active, such as changes to passwords, PINs, usernames, biometric features, etc.

If the data transaction does not satisfy the one or more transaction constraints (“No”), at 314 the data transaction is disallowed. The transaction application 110 and/or the network transaction service 104, for instance, may prevent the data transaction from being further processed and in at least one implementation can terminate the data transaction. Alternatively or additionally where the data transaction involves user account access separately from the transaction application 110, the access to the user account can be denied. A notification can be presented via the mobile device 102 indicating that the data transaction was disallowed and may provide a reason why it was disallowed, e.g., that the user was detected as potentially being in an impaired state and the data transaction failed one or more of the transaction constraints.

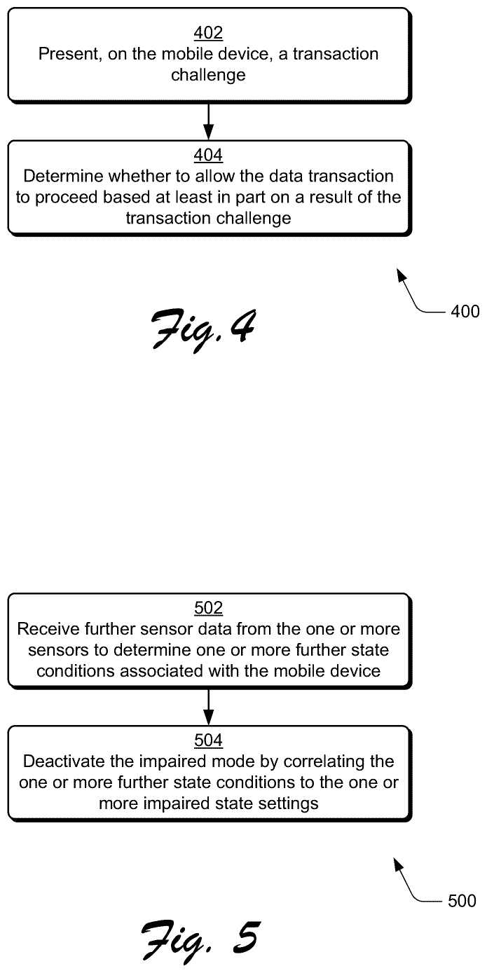

FIG. 4 illustrates a flow chart depicting an example method 400 for impaired mode for a mobile device in accordance with one or more implementations. Operations of the method 400, for instance, may be performed in the context of the environment 100, such as by the transaction application 110 on the mobile device 102.

At 402 a transaction challenge is presented on the mobile device. For instance, as part of processing a data transaction while in an impaired mode and to determine whether to allow the data transaction, the transaction application 110 and/or other user account access can present a transaction challenge. The transaction challenge, for instance, represents a type of query that requests that the user provide input that matches a correct answer to the challenge. The transaction challenge can be implemented in various ways, such as one or more questions, a puzzle, a request for the user to verbally recite a phrase (e.g., to detect possible slurred speech), etc. For example, the user's recital of the phrase can be compared with previously captured user speech to determine if the recital of the phrase may indicate potential impairment.

At 404 it is determined whether to allow the data transaction to proceed based at least in part on a result of the transaction challenge. For instance, if the user provides a correct answer to the transaction challenge the transaction application 110 and/or other user account access may allow the data transaction to proceed. However, if the user cannot provide a correct answer to the transaction challenge the transaction application 110 and/or other user account access may disallow the data transaction to proceed.

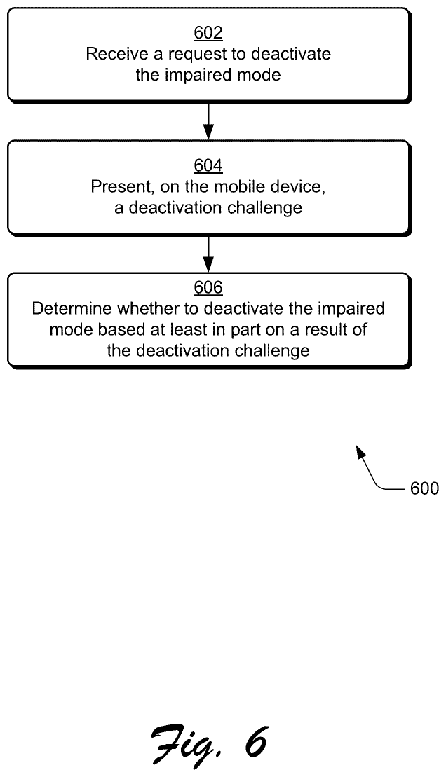

FIG. 5 illustrates a flow chart depicting an example method 500 for impaired mode for a mobile device in accordance with one or more implementations. Operations of the method 500, for instance, may be performed in the context of the environment 100, such as by the transaction application 110 on the mobile device 102.

At 502 further sensor data is received from the one or more sensors to determine one or more further state conditions associated with the mobile device. For example, while an impaired mode is active, the transaction application 110 continues to receive sensor data from the sensors 126 and determine state conditions of the mobile device 102, such as location, time of day, persons in proximity, motion attributes, etc.

At 504 the impaired mode is deactivated by correlating the one or more further state conditions to the one or more impaired state settings. The transaction application 110, for example, determines based on the state conditions of the mobile device 102 that the user 106 may no longer be at risk for impairment and thus the impaired mode can be deactivated. With the impaired mode deactivated data transactions may proceed as normal, e.g., without applying transaction constraints to the data transactions.

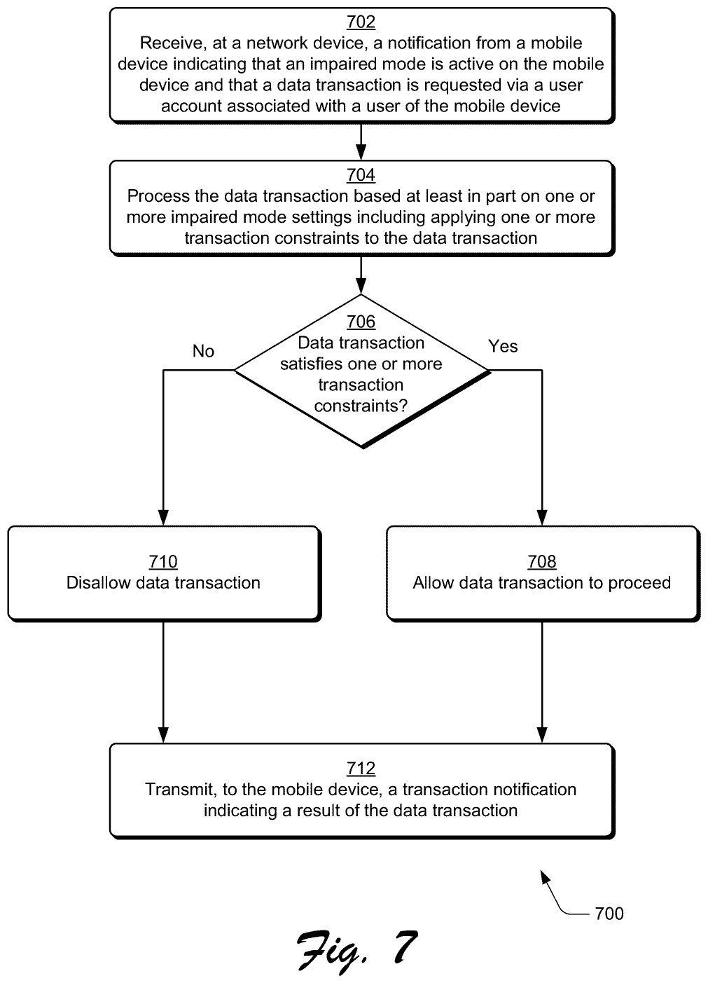

FIG. 6 illustrates a flow chart depicting an example method 600 for impaired mode for a mobile device in accordance with one or more implementations. Operations of the method 600, for instance, may be performed in the context of the environment 100, such as by the transaction application 110 on the mobile device 102.

At 602 a request is received to deactivate the impaired mode. For example, while an impaired mode is active, a user inputs a request to the transaction application 110 to deactivate the impaired mode. At 604 a deactivation challenge is presented on the mobile device. The transaction application 110, for instance, presents the deactivation challenge. The deactivation challenge may be implemented in various ways, examples of which are described above with reference to the transaction challenge.

At 606 it is determined whether to deactivate the impaired mode based at least in part on a result of the deactivation challenge. For instance, if the user correctly answers and/or completes the deactivation challenge, the transaction application 110 may deactivate the impaired mode. However, if the user fails the deactivation challenge, the impaired mode may remain active and the user may be notified that they failed the deactivation challenge and that the impaired mode remains active.

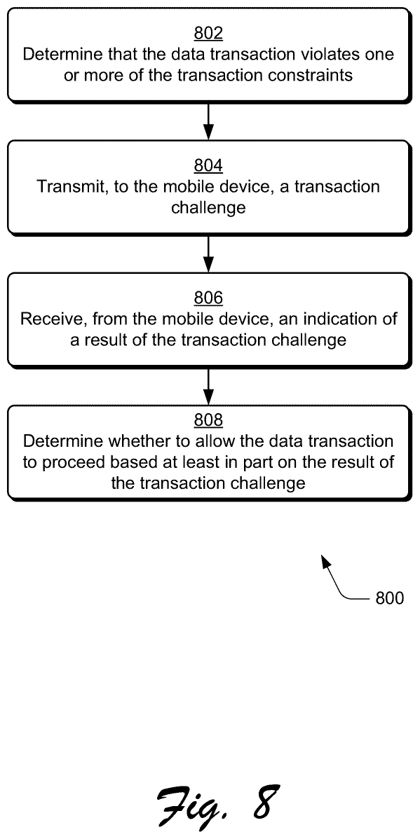

FIG. 7 illustrates a flow chart depicting an example method 700 for impaired mode for a mobile device in accordance with one or more implementations. Operations of the method 700, for instance, may be performed in the context of the environment 100, such as by the impaired state service 128 at the network transaction service 104.

At 702 a notification from a mobile device is received at a network device indicating that an impaired mode is active on the mobile device and that a data transaction is requested via a user account associated with a user of the mobile device. For instance, when an impaired mode is activated on the mobile device 102, the mobile device 102 receives a request to perform a data transaction via a user account associated with the mobile device. The mobile device 102 transmits a notification to the network transaction service 104 of the requested data transaction and that the impaired mode is active on the mobile device 102. The user account can be implemented in different ways, such as via the transaction application 110, via a different type of user account (such as via a card access to a financial-related account), a credit account with a vendor or other entity, etc.

At 704 the data transaction is processed based at least in part on one or more impaired mode settings including applying one or more transaction constraints to the data transaction. Various transaction constraints are described throughout this disclosure.

At 706 it is determined whether the data transaction satisfies the one or more transaction constraints. If the data transaction satisfies the one or more transaction constraints (“Yes”), at 708 the data transaction is allowed. If the data transaction does not satisfy the one or more transaction constraints (“No”), at 710 the data transaction is disallowed. At 712 a transaction notification is transmitted to the mobile device indicating a result of the data transaction. The impaired state service 128, for instance, causes a notification to be transmitted to the mobile device 102 indicating whether the data transaction was allowed or disallowed.

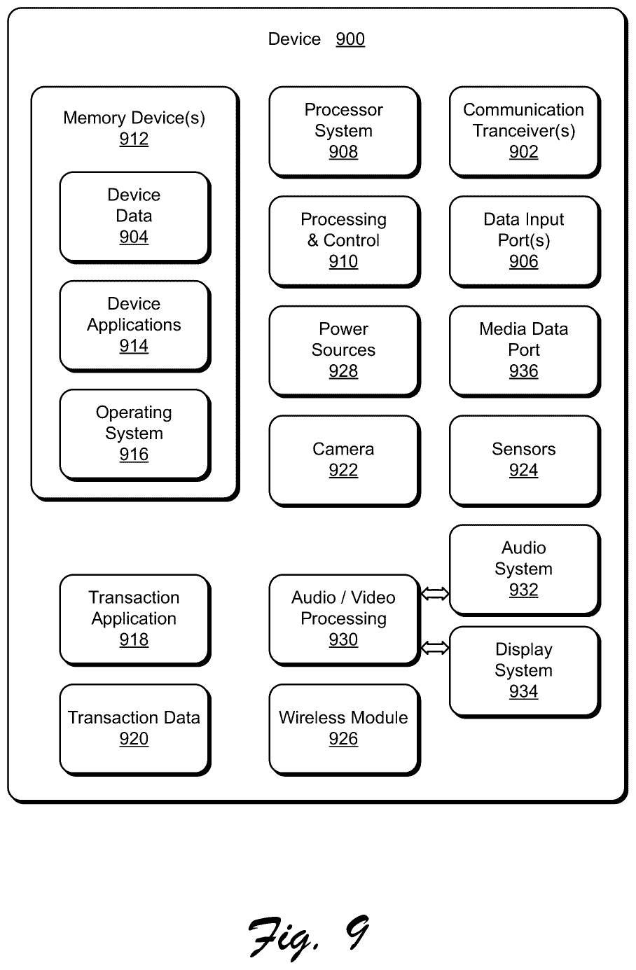

FIG. 8 illustrates a flow chart depicting an example method 800 for impaired mode for a mobile device in accordance with one or more implementations. Operations of the method 800, for instance, may be performed in the context of the environment 100, such as by the impaired state service 128 at the network transaction service 104.

At 802 it is determined that the data transaction violates one or more of the transaction constraints. For instance, while an impaired mode is active on the mobile device 102, the impaired state service 128 receives a request from the mobile device 102 and/or other implementation of a user account to perform a data transaction that violates at least one transaction constraint.

At 804 a transaction challenge is transmitted to the mobile device. The impaired state service 128, for example, causes a transaction challenge to be transmitted to the mobile device 102. Example attributes of the transaction challenge are detailed above.

At 806 an indication of a result of the transaction challenge is received from the mobile device. For instance, the impaired state service 128 receives an answer to the transaction challenge from the mobile device 102. At 808 it is determined whether to allow the data transaction to proceed based at least in part on the result of the transaction challenge. For example, if the transaction challenge is correctly answered the impaired state service 128 allows the data transaction to proceed. However, if the transaction challenge is not correctly answered, the impaired state service 128 can disallow the data transaction.

The example methods described above may be performed in various ways, such as for implementing different aspects of the systems and scenarios described herein. Generally, any services, components, modules, methods, and/or operations described herein can be implemented using software, firmware, hardware (e.g., fixed logic circuitry), manual processing, or any combination thereof. Some operations of the example methods may be described in the general context of executable instructions stored on computer-readable storage memory that is local and/or remote to a computer processing system, and implementations can include software applications, programs, functions, and the like. Alternatively or in addition, any of the functionality described herein can be performed, at least in part, by one or more hardware logic components, such as, and without limitation, Field-programmable Gate Arrays (FPGAs), Application-specific Integrated Circuits (ASICs), Application-specific Standard Products (ASSPs), System-on-a-chip systems (SoCs), Complex Programmable Logic Devices (CPLDs), and the like. The order in which the methods are described is not intended to be construed as a limitation, and any number or combination of the described method operations can be performed in any order to perform a method, or an alternate method.

FIG. 9 illustrates various components of an example device 900 in which aspects of impaired mode for a mobile device can be implemented. The example device 900 can be implemented as any of the devices described with reference to the previous FIGS. 1-8, such as any type of mobile device, mobile phone, mobile device, wearable device, tablet, computing, communication, entertainment, gaming, media playback, and/or other type of electronic device. For example, the mobile device 102 and/or the network transaction service 104 as shown and described with reference to FIGS. 1-8 may be implemented as the example device 900.

The device 900 includes communication transceivers 902 that enable wired and/or wireless communication of device data 904 with other devices. The device data 904 can include one or more of device identifying data, device location data, wireless connectivity data, and wireless protocol data. Additionally, the device data 904 can include any type of audio, video, and/or image data. Example communication transceivers 902 include wireless personal area network (WPAN) radios compliant with various IEEE 802.15 (Bluetooth™) standards, wireless local area network (WLAN) radios compliant with any of the various IEEE 802.10 (Wi-Fi™) standards, wireless wide area network (WWAN) radios for cellular phone communication, wireless metropolitan area network (WMAN) radios compliant with various IEEE 802.16 (WiMAX™) standards, and wired local area network (LAN) Ethernet transceivers for network data communication.

The device 900 may also include one or more data input ports 906 via which any type of data, media content, and/or inputs can be received, such as user-selectable inputs to the device, messages, music, television content, recorded content, and any other type of audio, video, and/or image data received from any content and/or data source. The data input ports may include USB ports, coaxial cable ports, and other serial or parallel connectors (including internal connectors) for flash memory, DVDs, CDs, and the like. These data input ports may be used to couple the device to any type of components, peripherals, or accessories such as microphones and/or cameras.

The device 900 includes a processing system 908 of one or more processors (e.g., any of microprocessors, controllers, and the like) and/or a processor and memory system implemented as a system-on-chip (SoC) that processes computer-executable instructions. The processor system may be implemented at least partially in hardware, which can include components of an integrated circuit or on-chip system, an application-specific integrated circuit (ASIC), a field-programmable gate array (FPGA), a complex programmable logic device (CPLD), and other implementations in silicon and/or other hardware. Alternatively or in addition, the device can be implemented with any one or combination of software, hardware, firmware, or fixed logic circuitry that is implemented in connection with processing and control circuits, which are generally identified at 910. The device 900 may further include any type of a system bus or other data and command transfer system that couples the various components within the device. A system bus can include any one or combination of different bus structures and architectures, as well as control and data lines.

The device 900 also includes computer-readable storage memory 912 (e.g., memory devices) that enable data storage, such as data storage devices that can be accessed by a computing device, and that provide persistent storage of data and executable instructions (e.g., software applications, programs, functions, and the like). Examples of the computer-readable storage memory 912 include volatile memory and non-volatile memory, fixed and removable media devices, and any suitable memory device or electronic data storage that maintains data for computing device access. The computer-readable storage memory can include various implementations of random access memory (RAM), read-only memory (ROM), flash memory, and other types of storage media in various memory device configurations. The device 900 may also include a mass storage media device.

The computer-readable storage memory 912 provides data storage mechanisms to store the device data 904, other types of information and/or data, and various device applications 914 (e.g., software applications). For example, an operating system 916 can be maintained as software instructions with a memory device and executed by the processing system 908. The device applications may also include a device manager, such as any form of a control application, software application, signal-processing and control module, code that is native to a particular device, a hardware abstraction layer for a particular device, and so on. Computer-readable storage memory 912 represents media and/or devices that enable persistent and/or non-transitory storage of information in contrast to mere signal transmission, carrier waves, or signals per se. Computer-readable storage memory 912 do not include signals per se or transitory signals.

In this example, the device 900 includes a transaction application 918 that implements aspects of impaired mode for a mobile device and may be implemented with hardware components and/or in software as one of the device applications 914. For example, the transaction application 918 can be implemented as the transaction application 110 described in detail above. In implementations, the transaction application 918 may include independent processing, memory, and logic components as a computing and/or electronic device integrated with the device 900. The device 900 also includes transaction data 920 for implementing aspects of impaired mode for a mobile device and may include data from the transaction application 918, such as data for managing data transaction requests.

In this example, the example device 900 also includes a camera 922 and sensors 924. The sensors 924 can be implemented in various ways and are representative of functionality to detect various physical and/or logical phenomena in relation to the device 900, such as motion, light, image detection and recognition, time and date, position, location, touch detection, sound, temperature, and so forth. Examples of the sensors 924 include hardware and/or logical sensors such as an accelerometer, a gyroscope, a camera, a microphone, a clock, biometric sensors, touch input sensors, position sensors, environmental sensors (e.g., for temperature, pressure, humidity, and so on), geographical location information sensors (e.g., Global Positioning System (GPS) functionality), and so forth.

The device 900 also includes a wireless module 926, which is representative of functionality to perform various wireless communication tasks. The device 900 can also include one or more power sources 928, such as when the device is implemented as a mobile device. The power sources 928 may include a charging and/or power system, and can be implemented as a flexible strip battery, a rechargeable battery, a charged super-capacitor, and/or any other type of active or passive power source.

The device 900 also includes an audio and/or video processing system 930 that generates audio data for an audio system 932 and/or generates display data for a display system 934. The audio system and/or the display system may include any devices that process, display, and/or otherwise render audio, video, display, and/or image data. Display data and audio signals can be communicated to an audio component and/or to a display component via an RF (radio frequency) link, S-video link, HDMI (high-definition multimedia interface), composite video link, component video link, DVI (digital video interface), analog audio connection, or other similar communication link, such as media data port 936. In implementations, the audio system and/or the display system are integrated components of the example device. Alternatively, the audio system and/or the display system are external, peripheral components to the example device.

Although implementations of impaired mode for a mobile device have been described in language specific to features and/or methods, the subject of the appended claims is not necessarily limited to the specific features or methods described. Rather, the features and methods are disclosed as example implementations, and other equivalent features and methods are intended to be within the scope of the appended claims. Further, various different examples are described and it is to be appreciated that each described example can be implemented independently or in connection with one or more other described examples. Additional aspects of the techniques, features, and/or methods discussed herein relate to one or more of the following:

In some aspects, the techniques described herein relate to a mobile device including: one or more sensors; at least one processor; and computer-readable storage media storing instructions that are executable by the at least one processor to: receive sensor data from the one or more sensors to determine one or more state conditions associated with the mobile device; trigger an impaired mode for the mobile device by correlating the one or more state conditions to one or more impaired state settings; receive a request to perform a data transaction via a user account of a user associated with the mobile device; and process the data transaction based at least in part on one or more impaired mode settings.

In some aspects, the techniques described herein relate to a mobile device, wherein the one or more state conditions include a location of the mobile device and the one or more impaired state settings identify the location as a high risk location for impairment.

In some aspects, the techniques described herein relate to a mobile device, wherein the one or more state conditions include a time value and the one or more impaired state settings identify the time value as a high risk time value for impairment.

In some aspects, the techniques described herein relate to a mobile device, wherein the one or more state conditions include a person detected in proximity to the mobile device and the one or more impaired state settings identify the person as a high risk person for impairment.

In some aspects, the techniques described herein relate to a mobile device, wherein the one or more state conditions include a detected motion pattern of the mobile device and the one or more impaired state settings identify the motion pattern as a high risk motion pattern for impairment.

In some aspects, the techniques described herein relate to a mobile device, wherein the one or more state conditions include a combination of two or more of a location of the mobile device, a time value, a person detected in proximity to the mobile device, or a detected motion pattern of the mobile device.

In some aspects, the techniques described herein relate to a mobile device, wherein to trigger the impaired mode, the instructions are executable by the at least one processor to: present a query via the mobile device requesting whether to activate the impaired mode; and activate the impaired mode in response to input to the query.

In some aspects, the techniques described herein relate to a mobile device, wherein to process the data transaction based at least in part on one or more impaired mode settings, the instructions are executable by the at least one processor to apply one or more transaction constraints to the data transaction.

In some aspects, the techniques described herein relate to a mobile device, wherein the one or more transaction constraints includes one or more of: a maximum spend threshold; a location constraint; a change in authentication mode; one or more transaction types; or a change to authentication-related information.

In some aspects, the techniques described herein relate to a mobile device, wherein to process the data transaction based at least in part on one or more impaired mode settings, the instructions are executable by the at least one processor to: present, on the mobile device, a transaction challenge; and determine whether to allow the data transaction to proceed based at least in part on a result of the transaction challenge.

In some aspects, the techniques described herein relate to a mobile device, wherein in response to the trigger of the impaired mode and prior to the request to perform the data transaction, the instructions are executable by the at least one processor to present, on the mobile device, an option to provide a proactive data transaction.

In some aspects, the techniques described herein relate to a mobile device, wherein the instructions are executable by the at least one processor to: receive further sensor data from the one or more sensors to determine one or more further state conditions associated with the mobile device; and deactivate the impaired mode by correlating the one or more further state conditions to the one or more impaired state settings.

In some aspects, the techniques described herein relate to a mobile device, wherein the instructions are executable by the at least one processor to: receive a request to deactivate the impaired mode; present, on the mobile device, a deactivation challenge; and determine whether to deactivate the impaired mode based at least in part on a result of the deactivation challenge.

In some aspects, the techniques described herein relate to a method including: triggering an impaired mode for a user account by correlating one or more state conditions associated with a mobile device to one or more impaired state settings; receiving a request to perform a data transaction via the user account; and processing the data transaction based at least in part on one or more impaired mode settings including applying one or more transaction constraints to the data transaction.

In some aspects, the techniques described herein relate to a method, wherein: the one or more state conditions include one or more of a location of the mobile device, a time value, a person detected in proximity to the mobile device, or a detected motion pattern of the mobile device; and the one or more transaction constraints include one or more of a maximum spend threshold, a location constraint, a change in authentication mode, one or more transaction types, or a change to authentication-related information.

In some aspects, the techniques described herein relate to a system including: at least one memory; and at least one processor coupled to the at least one memory and configured to cause the system to: receive, at a network device, a notification from a mobile device indicating that an impaired mode is active on the mobile device and that a data transaction is requested via a user account; process the data transaction based at least in part on one or more impaired mode settings including applying one or more transaction constraints to the data transaction; and transmit, to the mobile device, a transaction notification indicating a result of the data transaction.

In some aspects, the techniques described herein relate to a system, wherein the one or more transaction constraints include one or more of: a maximum spend threshold; a location constraint; a change in authentication mode; one or more transaction types; or a change to authentication-related information.

In some aspects, the techniques described herein relate to a system, wherein the notification includes an indication of one or more of the maximum spend threshold, the location constraint, the change in authentication mode, the one or more transaction types, or the change to authentication-related information.

In some aspects, the techniques described herein relate to a system, wherein the result of the data transaction includes one or more of: whether the data transaction was allowed based on the maximum spend threshold; whether the data transaction was allowed based on the location constraint; whether the data transaction was allowed based on the change in authentication mode: whether the data transaction was allowed based on the one or more transaction types; or whether the data transaction was allowed based on the change to authentication-related information.

In some aspects, the techniques described herein relate to a system, wherein to process the data transaction, the at least one processor is configured to cause the system to: determine that the data transaction violates one or more of the transaction constraints; transmit, to the mobile device, a transaction challenge; receive, from the mobile device, an indication of a result of the transaction challenge; and determine whether to allow the data transaction to proceed based at least in part on the result of the transaction challenge.

1. A mobile device comprising:
one or more sensors;
at least one processor, and computer-readable storage media storing instructions that are executable by the at least one processor to:
receive sensor data from the one or more sensors to determine one or more state conditions associated with the mobile device;
trigger an impaired mode for the mobile device by correlating the one or more state conditions to one or more impaired state settings;
receive a request to perform a data transaction via a user account of a user associated with the mobile device; and
process the data transaction based at least in part on one or more impaired mode settings.

2. The mobile device of claim 1, wherein the one or more state conditions comprise a location of the mobile device and the one or more impaired state settings identify the location as a high risk location for impairment.

3. The mobile device of claim 1, wherein the one or more state conditions comprise a time value and the one or more impaired state settings identify the time value as a high risk time value for impairment.

4. The mobile device of claim 1, wherein the one or more state conditions comprise a person detected in proximity to the mobile device and the one or more impaired state settings identify the person as a high risk person for impairment.

5. The mobile device of claim 1, wherein the one or more state conditions comprise a detected motion pattern of the mobile device and the one or more impaired state settings identify the motion pattern as a high risk motion pattern for impairment.

6. The mobile device of claim 1, wherein the one or more state conditions comprise a combination of two or more of a location of the mobile device, a time value, a person detected in proximity to the mobile device, or a detected motion pattern of the mobile device.

7. The mobile device of claim 1, wherein to trigger the impaired mode, the instructions are executable by the at least one processor to:
present a query via the mobile device requesting whether to activate the impaired mode; and
activate the impaired mode in response to input to the query.

8. The mobile device of claim 1, wherein to process the data transaction based at least in part on one or more impaired mode settings, the instructions are executable by the at least one processor to apply one or more transaction constraints to the data transaction.

9. The mobile device of claim 8, wherein the one or more transaction constraints comprises one or more of:
a maximum spend threshold;
a location constraint;
a change in authentication mode;
one or more transaction types; or
a change to authentication-related information.

10. The mobile device of claim 8, wherein to process the data transaction based at least in part on one or more impaired mode settings, the instructions are executable by the at least one processor to:
present, on the mobile device, a transaction challenge; and
determine whether to allow the data transaction to proceed based at least in part on a result of the transaction challenge.

11. The mobile device of claim 1, wherein in response to the trigger of the impaired mode and prior to the request to perform the data transaction, the instructions are executable by the at least one processor to present, on the mobile device, an option to provide a proactive data transaction.

12. The mobile device of claim 1, wherein the instructions are executable by the at least one processor to:
receive further sensor data from the one or more sensors to determine one or more further state conditions associated with the mobile device; and
deactivate the impaired mode by correlating the one or more further state conditions to the one or more impaired state settings.

13. The mobile device of claim 1, wherein the instructions are executable by the at least one processor to:
receive a request to deactivate the impaired mode;
present, on the mobile device, a deactivation challenge; and
determine whether to deactivate the impaired mode based at least in part on a result of the deactivation challenge.

14. A method comprising:
triggering an impaired mode for a user account by correlating one or more state conditions associated with a mobile device to one or more impaired state settings;
receiving a request to perform a data transaction via the user account; and
processing the data transaction based at least in part on one or more impaired mode settings including applying one or more transaction constraints to the data transaction.

15. The method of claim 14, wherein:
the one or more state conditions comprise one or more of a location of the mobile device, a time value, a person detected in proximity to the mobile device, or a detected motion pattern of the mobile device; and
the one or more transaction constraints comprise one or more of a maximum spend threshold, a location constraint, a change in authentication mode, one or more transaction types, or a change to authentication-related information.

16. A system comprising:
at least one memory; and
at least one processor coupled to the at least one memory and configured to cause the system to:
receive, at a network device, a notification from a mobile device indicating that an impaired mode is active on the mobile device and that a data transaction is requested via a user account;
process the data transaction based at least in part on one or more impaired mode settings including applying one or more transaction constraints to the data transaction; and
transmit, to the mobile device, a transaction notification indicating a result of the data transaction.

17. The system of claim 16, wherein the one or more transaction constraints comprise one or more of:
a maximum spend threshold;
a location constraint;
a change in authentication mode;
one or more transaction types; or
a change to authentication-related information.

18. The system of claim 17, wherein the notification comprises an indication of one or more of the maximum spend threshold, the location constraint, the change in authentication mode, the one or more transaction types, or the change to authentication-related information.

19. The system of claim 17, wherein the result of the data transaction comprises one or more of:
whether the data transaction was allowed based on the maximum spend threshold;
whether the data transaction was allowed based on the location constraint;
whether the data transaction was allowed based on the change in authentication mode;
whether the data transaction was allowed based on the one or more transaction types; or
whether the data transaction was allowed based on the change to authentication-related information.

20. The system of claim 16, wherein to process the data transaction, the at least one processor is configured to cause the system to:
determine that the data transaction violates one or more of the transaction constraints;
transmit, to the mobile device, a transaction challenge;
receive, from the mobile device, an indication of a result of the transaction challenge; and
determine whether to allow the data transaction to proceed based at least in part on the result of the transaction challenge.
